(19) United States
(12) Patent Application Publication
(10) Pub. No.: US 2026/0149328 A1
(43) Pub. Date: May 28, 2026

(54) ENHANCED MOTOR HOUSING FOR MOTOR AND PUMP SYSTEM

(71) Applicant: Johnson Electric Motion Technology Canada Ltd., Vancouver (CA)

(72) Inventor: Daniel KIENINGER, Ancaster (CA)

(21) Appl. No.: 19/398,908

(22) Filed: Nov. 24, 2025

Related U.S. Application Data
(60) Provisional application No. 63/725,391, filed on Nov. 26, 2024.

(51) Int. Cl. H02K 5/04; F04C 2/10; F04C 15/00; H02K 7/14; H02K 15/142

(52) U.S. Cl. CPC H02K 5/04; F04C 2/10; F04C 15/008; H02K 7/14; H02K 15/142; F04C 2230/23; F04C 2240/30

(57) ABSTRACT

A pump system, and method of manufacturing the same, and a vehicle includes: a housing with a pump for pumping a liquid and an electric motor therein. A stator of the electric motor has a lamination stack, the lamination stack being mounted between a first motor housing portion and a second motor housing portion. The second motor housing portion is attached to the lamination stack, and the first motor housing portion includes an integrated internal frame shaped to receive the lamination stack and parts of the stator therein, the first motor housing portion forming part of a motor housing for the electric motor. The integrated internal frame and the first motor housing portion may be formed as a single, continuous part, e.g., molded from plastic.

### CROSS REFERENCE TO RELATED APPLICATION(S)

This application claims priority to U.S. Provisional Ser. No. 63/725,391, filed Nov. 26, 2024, the entire contents of which are herein incorporated by reference.

### BACKGROUND

### Field

The present disclosure is generally related to an electric motor and its housing when utilized in a pump assembly/system including a pump, a motor and a controller. At least part of the motor housing has integrated parts therein for the stator assembly.

### Description of Related Art

An electric motor in an ePump assembly has a stator—made up of bobbins, laminations, and windings—and rotor. Traditionally, the stator is a separate component which is added to the housing for the motor, and is held in place via some fixation feature(s), such as screws, press-fit portions, etc.

Motor housings are typically formed using metal components, such as aluminum and/or steel.

Alternatives are desirable to reduce the cost and weight of the stator assembly for the motor, and also to remove engineering and quality challenges that typically come with fixing a stator to a housing and aligning it with the pump assembly.

### SUMMARY

It is an aspect of this disclosure to provide a pump system that includes a housing with a pump for pumping a liquid and an electric motor therein. A stator of the electric motor has a lamination stack, the lamination stack being mounted between a first motor housing portion and a second motor housing portion. The second motor housing portion is attached to the lamination stack, and the first motor housing portion includes an integrated internal frame shaped to receive the lamination stack and parts of the stator therein, the first motor housing portion forming part of a motor housing for the electric motor. The integrated internal frame and the first motor housing portion may be formed as a single, continuous part, e.g., molded from plastic.

Another aspect of this disclosure includes a method of manufacturing such a pump system.

Yet another aspect of this disclosure includes a vehicle having the pump system.

Other aspects, features, and advantages of the present disclosure will become apparent from the following detailed description, the accompanying drawings, and the appended claims.

### BRIEF DESCRIPTION OF THE DRAWINGS

FIG. 1 shows a schematic view of a pump system in accordance with an embodiment of the disclosure.

FIG. 2 shows an example of a pump system having the features of FIG. 1 according to embodiments herein.

FIG. 3 illustrates a cross-sectional view of one exemplary embodiment of parts of a pump system as shown in FIG. 2, according to an embodiment.

FIG. 4 illustrates the same cross-sectional view of FIG. 3 showing additional parts of a motor housing and motor parts, according to an embodiment.

FIG. 5 shows motor rotor and motor stator parts in the system, according to an embodiment.

FIG. 6 is an exploded view of pump parts in the pump system, according to an embodiment.

FIG. 7 shows a wall, ring, and optional parts in the system, according to an embodiment.

FIG. 8 shows an exploded view of parts of the pump system of FIG. 2, according to an embodiment.

FIG. 9A shows a partial view of motor parts and motor housing in the pump system of FIG. 2, according to an embodiment; FIG. 9B shows the features of FIG. 9A with windings thereon, according to an embodiment.

FIG. 10 shows a detailed view of a motor housing portion in the system, according to an embodiment.

FIG. 11 is an exploded view of the parts of FIG. 5, according to an embodiment.

FIG. 12 shows motor parts and cover of the system, according to an embodiment.

### DETAILED DESCRIPTION OF THE PREFERRED EMBODIMENT(S)

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) may be practiced without those specific details. In some instances, well-known structures and components may be shown in block diagram form in order to avoid obscuring the concepts of the disclosed subject matter.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It is to be understood that terms such as “up,” “below,” “top,” “bottom,” “side,” “upper,” “lower,” “interior,” “exterior,” “inner,” “outer,” and the like that may be used herein merely describe points of reference and do not necessarily limit embodiments of the present disclosure to any particular orientation or configuration. Typically, such references will be to the orientation of the drawings for convenience of the reader. Furthermore, terms such as “first,” “second,” etc., merely identify one of a number of portions, components, steps, operations, functions, and/or points of reference as disclosed herein, and likewise do not necessarily limit embodiments of the present disclosure to any particular configuration or orientation, or any requirement that each number must be included or that they must be included in any particular order.

As understood by one of ordinary skill in the art, “pump displacement” or “displacement” as used throughout this disclosure refers to a volume of liquid or fluid (e.g., lubricant, oil) a pump is capable of moving during a specified period of time, i.e., a flow rate. For explanatory and simplicity purposes herein, the term “liquid” is utilized to reference fluid, lubricant, or oil that is pressurized and pumped by the pump in the disclosed system and provided to the motor cavity for cooling purposes; however, the terms may be used interchangeably throughout this disclosure.

As evident by the drawings and below description, the disclosed pump system (ePump) and method of manufacturing the same includes as assembly having an electric motor, with parts made of plastic, in an electric pump assembly. Rather than having the stator as a separate component that is added to the housing of the assembly and is held in place via some fixation feature, at least some parts are replaced with plastic molded parts and combined into the housing. In accordance with embodiments, interfacing features of a lower half of the stator assembly for the motor are formed in the housing of the motor to reduce cost and weight of the assembly, and also remove engineering and quality challenges that typically appear with fixing a stator to a housing and aligning it with the pump assembly, for example. Since a portion of the motor housing is affixed to the rest of the stator assembly via windings, no additional fixation of stator required. Also, a cover may optionally be bonded or attached to such parts to encapsulate the motor and controller therein, further removing interference fit and/or screwing process to fix stator to housing. These and other features and advantages are described further below.

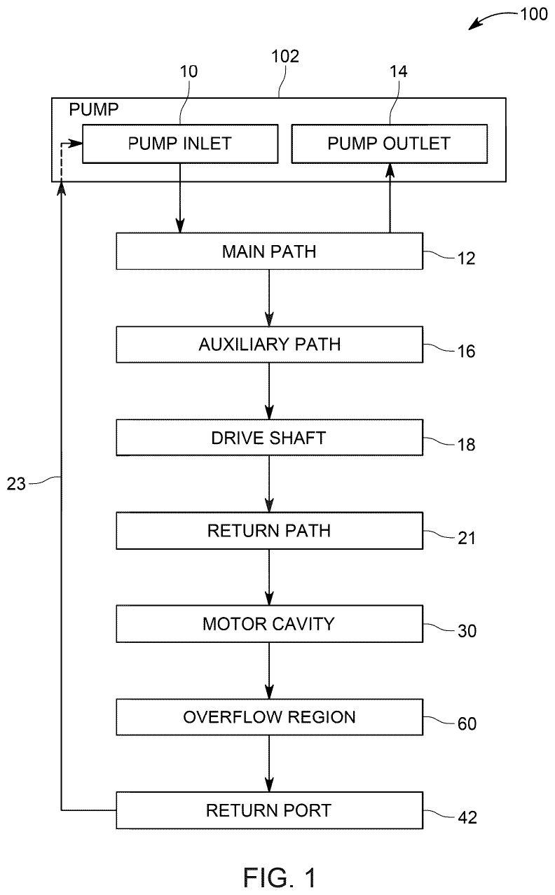

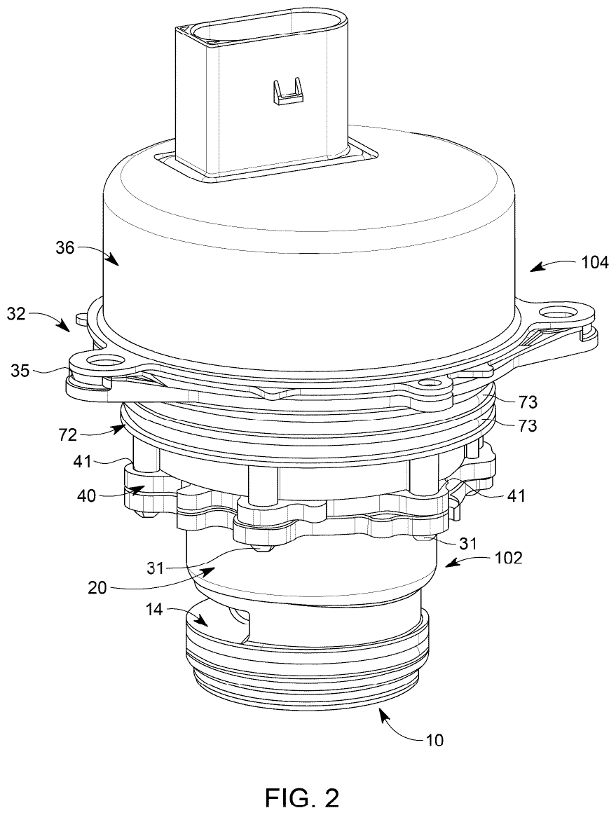

FIG. 1 shows a schematic view of a pump system 100 or pump assembly in accordance with an embodiment herein. FIG. 2 shows an example of such a pump system 100 in a system housing 104, in accordance with an embodiment. Pump system 100 may include an electronic pump 102, or e-pump, also referred to herein as simply a “pump 102”. The pump 102 is designed for pumping a liquid. In an embodiment, the pump system 100 is designed to provide power to actuate clutch or transmission.

In accordance with a non-limiting embodiment, pump system 100 may be a system or assembly such as described in U.S. Pat. No. 10,808,697 (U.S. Ser. No. 15/653,690) which is hereby incorporated by reference in its entirety herein, i.e., a pump assembly (or system) that has an assembly inlet for inputting fluid, an assembly outlet for outputting fluid, an electric motor contained within a motor casing, a pump having a pump housing, a drive shaft connecting the electric motor to the pump, and a controller configured to drive the electric motor. In such embodiment, the pump of the incorporated '697 patent has an inlet for receiving input fluid from the assembly inlet and a transfer outlet for outputting pressurized fluid; the drive shaft is configured to be driven about an axis by the electric motor; and the pump and the electric motor are on opposing axial sides of the controller. The pump assembly of the incorporated '697 patent also has a heat conductive plate positioned between the pump and the controller, for conducting heat from the controller; a transfer passage provided in the pump assembly for receiving the pressurized fluid output from the transfer outlet of the pump and directing the pressurized fluid along and in contact with the heat conductive plate to conduct heat therefrom into the pressurized fluid, and an outlet passage that communicates the transfer path with the assembly outlet to discharge the pressurized fluid. However, such assembly or system of the incorporated '697 patent is not limiting. Another example for pump system 100 may be a system or assembly such as described in U.S. application Ser. No. 15/653,690, which is also hereby incorporated by reference in its entirety herein. Other pump systems and/or features may be utilized.

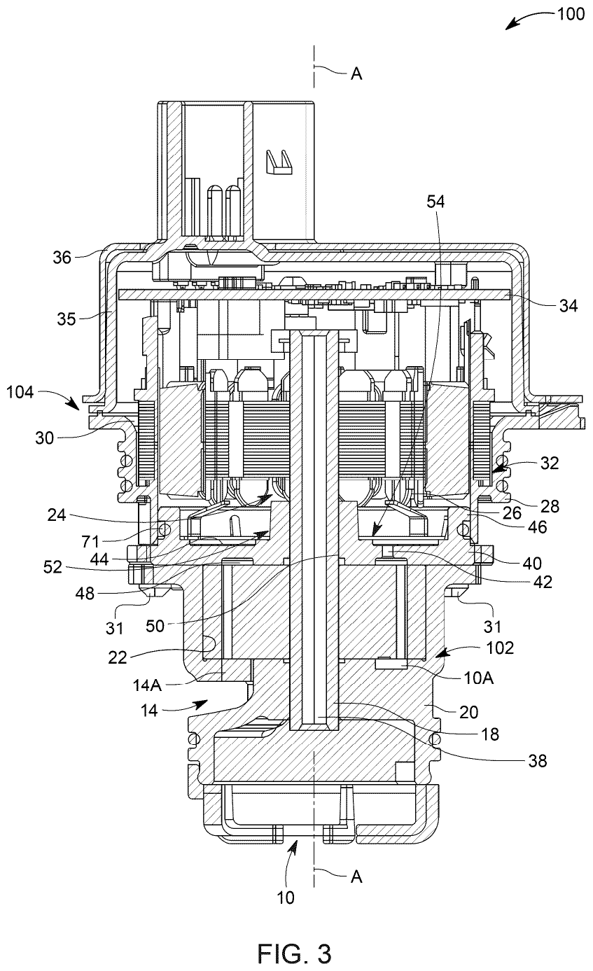

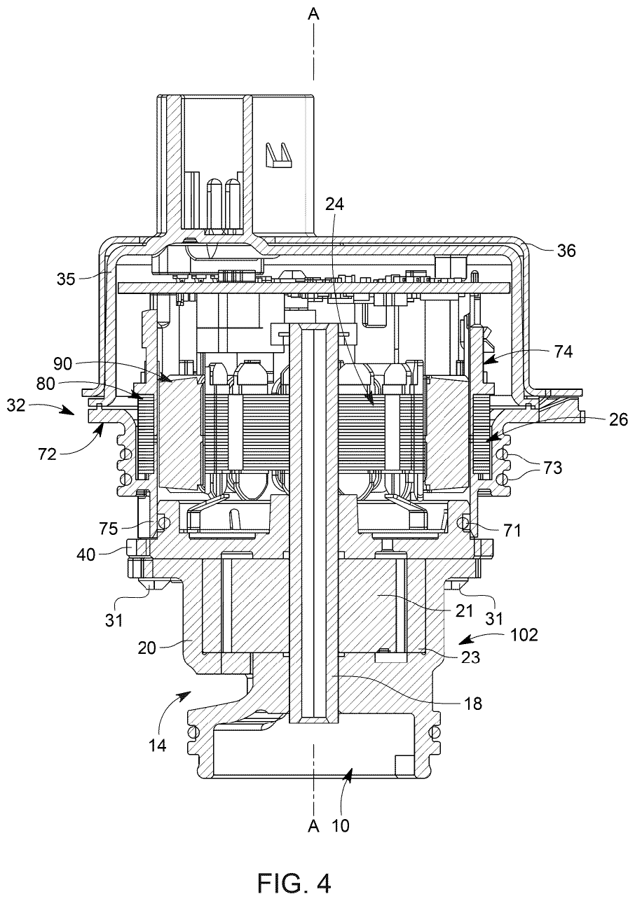

Pump system 100 has multiple structural sections that are connected to house or contain its parts therein, i.e., within a system housing 104, as shown in FIG. 2 and the cross-section of FIG. 3. In an embodiment, a pump housing 20 is provided as part of the system housing 104, which includes the pump 102 therein. An outer portion of the pump housing 20 may be generally cylindrical according to an embodiment. The pump housing 20 includes a pump chamber 22, which, in embodiments, may be cylindrical, ovular, or circular, for receiving parts of the pump 102 therein (noted later below). The pump housing 20 has a pump inlet 10 for receiving input fluid to direct said fluid to a pump inlet port that is connected to an inlet path (shown in FIG. 3) and a pump outlet 14 for outputting pressurized fluid from a pump outlet port. A drive shaft 18 (see, e.g., FIGS. 3 and 4) is provided for rotation about an axis A-A and rotatably driving parts of the pump 102 to pressurize the input fluid received through a fluid path for outputting pressurized fluid via the pump outlet 14.

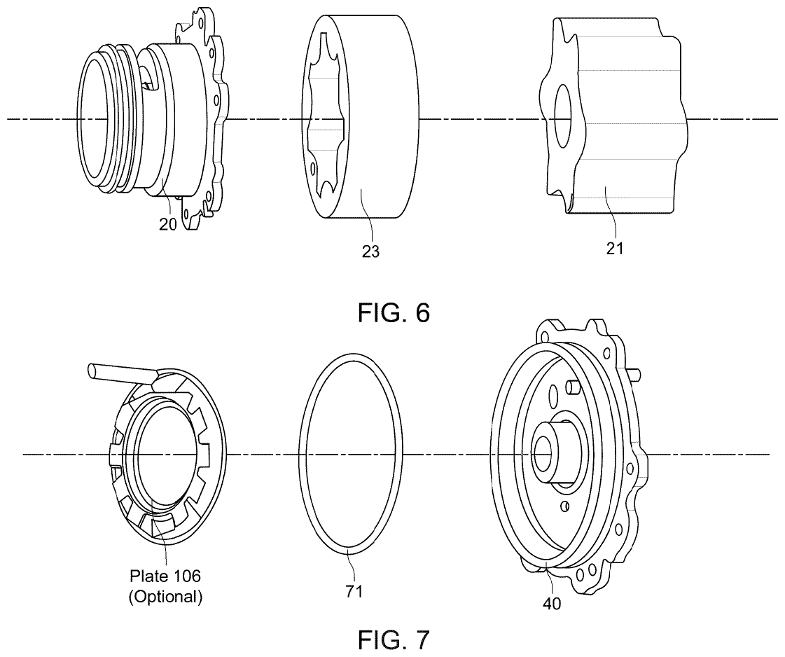

The type of pump 102 and its parts provided in the pump system/assembly 100 is not limited. In an embodiment, the pump 102 has a gerotor drive, wherein an inner rotor 21, shown in FIGS. 4 and 6, is rotatably driven by the drive shaft 18 to in turn rotatably drive an outer rotor 23. A pump end of the shaft 18 extends to (or through) a portion of the pump housing 20. The inner rotor 21 is fixedly secured to the shaft 18 for rotation about axis A-A with the drive shaft 18. The outer rotor 23 may be rotatably received in the pump chamber 22 of the housing 20. In embodiments, the pump chamber 22 and the outer surface of the outer rotor 23 are cylindrical (as shown in FIG. 6, for example). A motor end of the drive shaft 18 is positioned on an opposite side of an electric motor 32 (described below). Although not shown, it is generally known that the drive shaft 18 may be supported, for example, by journal bearings within housing(s) of the pump system 100. As is understood by one of ordinary skill in the art, rotation of the inner rotor 21 also rotates the outer rotor 23 via their intermeshed teeth to pressurize the input fluid received in areas between the complimentary parts for output from the pump 102, and thus such details are not described here. In accordance with a non-limiting embodiment herein, the inner rotor 21 and outer rotor 23 are part of gerotor pump and configured for operation like that which is disclosed in the aforementioned and incorporated U.S. '697 patent or the incorporated '690 application. In another non-limiting embodiment, the inner rotor 21 and outer rotor 23 are part of a gerotor pump and configured for operation like that which is disclosed in U.S. Pat. No. 5,722,815 (U.S. Ser. No. 08/515,054) which is also incorporated by reference in its entirety herein.

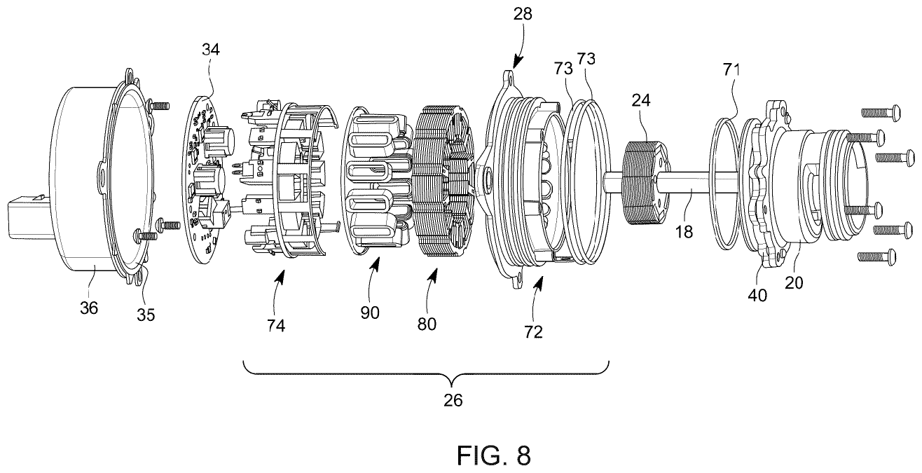

Other types of pump parts for pressurizing input fluid may also be used in pump in accordance with other embodiments, including gear pumps, vane pumps, etc., and thus pump 102 should not be limited to gerotor-type pumps. For example, in embodiments, an optional vent plate or fluid level control plate 106 (shown in FIG. 7) may be included in the pump housing 20, e.g., behind or relatively below the gearset (inner and outer rotors 21, 23). This plate 106 allows for positioning of the pump system 100 in different orientations (e.g., horizontal orientation). In embodiments, the plate 106 and pump system 100 may be similar to that as described U.S. Ser. No. 63/641,564, filed May 2, 2024, which is incorporated by reference herein in its entirety.

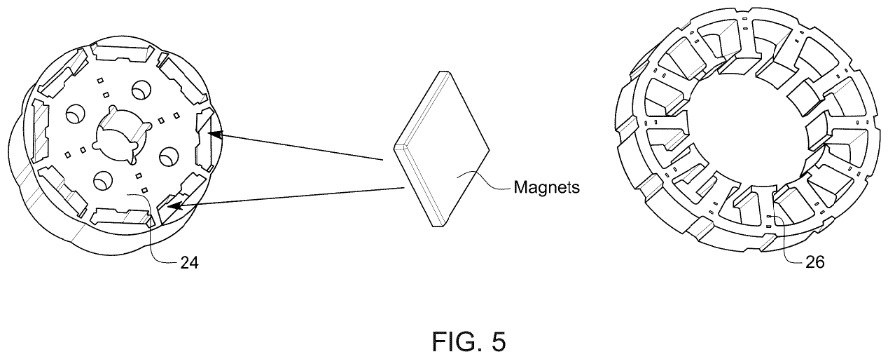

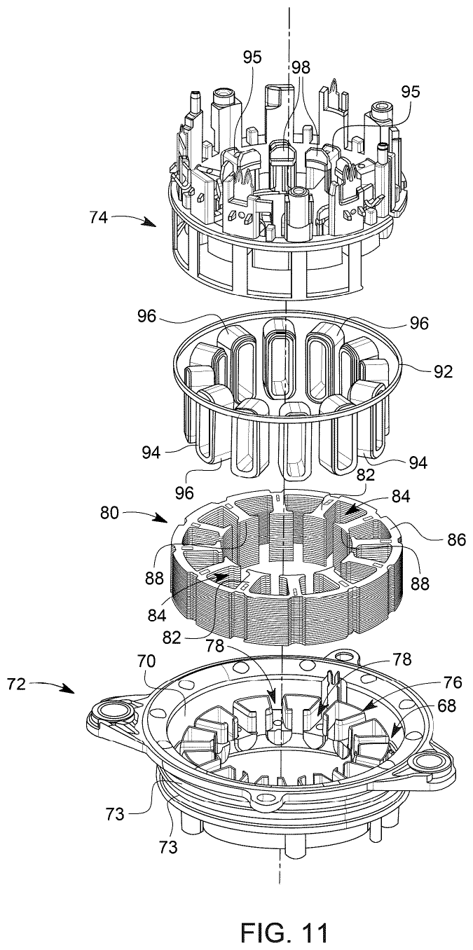

Pump system 100 also includes electric motor 32 for mechanical output and a motor drive shaft provided in system housing 104. In embodiments, the motor drive shaft and pump drive shaft 18 are the same drive shaft, i.e., one singular shaft, that extends through and from the motor 32 and through the pump 102. In another embodiment, the motor drive shaft and pump shaft are different parts. In the non-limiting illustrated embodiment, the electric motor 32 is connected to the pump 102 via the drive shaft 18, which is configured to be driven about axis A-A. The electric motor 32 is configured to drive the drive shaft 18 of the pump 102 via the motor drive shaft, to rotatably drive parts of the pump 102, i.e., to pressurize the input fluid, and to cool the motor/traction system or other device 32 using the liquid as a coolant (or for whatever reason the device requires fluid, such as for lubrication, general liquid delivery, etc.). As understood by those skilled in the art, the motor 32 includes a motor rotor 24 (see FIG. 5) and a motor stator 26 (a lamination stack portion 80 of which is shown in FIG. 5). Magnets are press fit into openings spaced around the motor rotor 24. The rotor 24 is connected to the motor drive shaft 18 and is contained within a motor casing 28 along with the stator 26. In an embodiment, the rotor 24 is press-fit onto the drive shaft 18. The motor casing 28 (or motor housing) is part of the system housing 104 and designed for connection to the pump housing 20. The motor casing 28 (also shown in FIG. 11) may be generally cylindrical and may include an inner motor cavity 30 or portion thereof for housing the rotor 24 and stator 26. The stator 26 may be optionally fixed to the motor casing 28. Further details regarding the motor housing 28, stator 26, and formation and assembly thereof, are described below with reference to FIGS. 4 and 8-11.

According to embodiments, the motor cavity 30 is designed for receipt of liquid (e.g., oil) therein. A cover 36 (optional) may be included as part of system housing 104 to assist in enclosing the motor cavity 30 and containing the liquid therein. In particular, as shown in the Figures, an opposite side or end of the motor casing 28 may optionally include cover 36 attached thereto for further containing at least the motor parts within and forming the motor cavity 30 in accordance with an embodiment. The motor casing 28 and cover 36 may include alignment devices for aligning and securement. Generally, the cover 36 may be laser welded axially for connection to motor housing portion 72 of the motor casing 28. However, any fastening technique may be used, including bolts, screws, snap-fitting, etc. Further, cover 36 need not be provided as part of the system, depending on user requirements.

In a non-limiting embodiment, an auxiliary circuit 16 or auxiliary fluid path is included in pump system 100, as schematically shown in FIG. 1. Auxiliary circuit 16 is configured to direct a portion (or percentage) of fluid flow to the motor cavity 30, according to embodiments herein. In embodiments, fluid or liquid directed through the auxiliary circuit 16 may deviate from the main path 12 of the pump 102. In an embodiment, the pump 102 uses negative pressure (suction), via a connection to the inlet port on the motor side of the pump 102, to draw the working fluid or liquid (e.g., oil) through a hollow shaft. In an embodiment, the auxiliary circuit 16 includes a path through an internal bore 38 in the drive shaft 18, for directing the portion of fluid flow into the motor cavity 30. In one exemplary embodiment, the auxiliary circuit 16 includes a fluid passageway defined in, at, or near the inlet 10 of the pump that deviates from the main path 12 to direct lubricant to the motor cavity 30 via the drive shaft 18. In particular, the auxiliary circuit 16 directs fluid through a length of the drive shaft 18 for outlet to a return path 25. After flowing to the motor end of the drive shaft 18, lubricant is redirected to return path 25 which includes a pathway of return flow for motor cooling. The return path 25 may include multiple pathways therein such that the fluid/lubricant is directed through a number of places of the motor parts. For example, the lubricant may be directed through multiple pathways through the rotor and stator components 24 and 26, and across the motor. The return path 25 includes redirecting a portion of flow of the liquid/fluid back to the pump 102. In accordance with an embodiment, the pump system 100 includes features as shown and described in U.S. application Ser. No. 63/641,564, filed May 2, 2024, entitled “Motor and Pump System with Fluid Level Control Plate” assigned to the same assignee, which is hereby incorporated by reference in its entirety.

In embodiments, the electric motor 32 may be further contained within the system housing 104 of the pump system 100 by a wall that separates the motor parts and parts of the pump 102. Specifically, according to embodiments herein, this wall may be an intermediate housing wall 40 is positioned between the pump 102 and the electric motor 32. The intermediate housing wall 40 covers motor cavity 30 on one side or end of the motor casing 28/within the housing for the electric motor 32. The intermediate housing wall 40 may be provided against / adjacent to and connected to each of the pump housing 20 as well as the motor casing 28. In an embodiment, the intermediate housing wall 40 may be a separate part or formed integrally therewith. For example, openings 41 (shown in FIG. 2) in the intermediate housing wall 40 may be spaced circumferentially around a lip of the wall 40 and aligned with corresponding openings on pump housing 20. Fasteners 31 and/or bolts may be inserted through the aligned openings to connect and secure the pump housing 20 and intermediate housing wall 40. The intermediate housing wall 40 may have a first axial side (also referred to as the pump-facing side, seen in FIG. 7) of the intermediate housing wall 40 that faces the pump 102. Additional features may be provided as described in the incorporated '564 application as well.

A second axial side (also referred to as the motor-facing side) of the intermediate housing wall 40, which is opposite to the first axial side, may include an extension wall 46 about its periphery and one or more recessed regions 44 therein, that face the electric motor 32 when mounted, which is shown in the cross-section of FIG. 3. In an embodiment, the extension wall 46 is designed for insertion to the motor casing 28 and sealing via an O-ring seal 71 (e.g., press-fit) to enclose the motor cavity 30. Thus, the intermediate housing wall 40 effectively acts as a cover for the pump 102 on the pump side and as a cover for the motor cavity 30 within the system housing 104 for the electric motor 32 on the motor side.

In addition, the drive shaft 18 may be configured to extend through an inner opening 50 within the intermediate housing wall 40, according to embodiments. This inner opening 50 may be a central opening within the wall 40. In one embodiment, the intermediate housing wall 40 may have an alignment portion 52 that surrounds the inner opening 50 and extends axially. Such an alignment portion may be provided for not only aligning the drive shaft 18 therethrough, but also for aligning additional parts (e.g., a fill level control plate 54 of the incorporated '564 application) within the system housing 104.

In embodiments, the intermediate housing wall 40 has a pump inlet return port 42 (see FIG. 3) for directing the fluid flow of the liquid from the motor cavity 30 to the pump 102. The pump inlet return port 42 may be an opening that extends axially and through a thickness of the wall 40. The inlet port 42 may be at any location.

In an embodiment, the system housing 104 further include an electronic control unit (ECU) or controller 34 therein. The controller 34 is configured, among other features, to drive the electric motor 32 to drive the drive shaft 18 of the pump 102. In the illustrated embodiments, the ECU is shown in the form of a printed circuit board (PCB) 34 with electrical components thereon. As known in the art, a number of components, such as sensors, temperature sensors/heat sink, etc. may mounted on the controller 34 or PCB. In an embodiment, the electric motor 32 is flanked by the controller 34 and the pump 102 in the pump assembly/system 100. That is, the pump 102 and the controller 34 may be on opposing sides of the electric motor 32.

In embodiments, which is also depicted in the Figures, the controller 34 may be provided within the motor cavity 30. That is, the controller 34 may be a “wet” controller associated with a wet motor and cooled via liquid in the motor cavity 30. Such a “wet” controller is submerged with the motor 32 in the motor cavity and in the liquid; as such, this liquid is configured to encompass the controller and its associated parts for cooling purposes as well. The controller may also be dry, but mounted on a structure that is in contact with the circulating liquid so that heat from the controller or parts thereof is exchanged through the structure to the circulating liquid. In other embodiments, the controller may be separate and cooled by other means.

Of course, it should be understood that, in accordance with embodiments herein, particularly when the controller 34 is provided in the motor cavity 30, any provided auxiliary circuit may include directing liquid towards sensors and devices associated with or mounted on the controller 34. Such sensors and devices may be directly exposed to the path 16, according to an embodiment. However, such devices and sensors may not be exposed directly to the liquid being pumped. Similarly, the controller 34 does not need to be a wet controller that is included in the motor cavity 30 and subject to liquid. Rather, the cover 36 may include a closed housing portion therein for housing the controller and electronics, without being exposed to the liquid.

It should be understood that the auxiliary circuit may also assist in drawing heat, i.e., cooling, additional parts within the pump system 100 or assembly. Such parts may include, but are not limited to, cooling the controller/ECU (by way of the flow of fluid/lubricant through the path and drawing heat therefrom and its components) and/or cooling the housing components used to secure the motor parts therein.

The materials used to form the system housing 104 may vary. In embodiments, the motor casing 28 and/or intermediate housing wall 40 may be formed from plastic. In embodiments, intermediate housing wall 40 may be formed from metal. In embodiments, cover 36 may be formed from metal, such as (but not limited to) steel. According to embodiments, cover 36 may be formed from plastic. Also in embodiments, cover 35 may be formed from plastic.

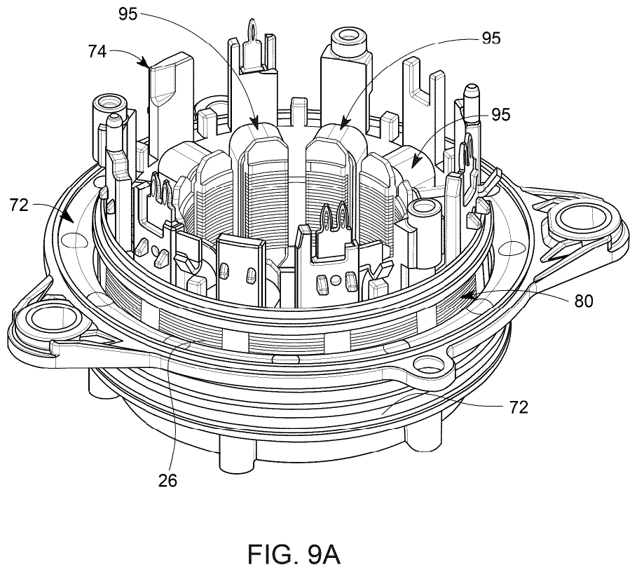

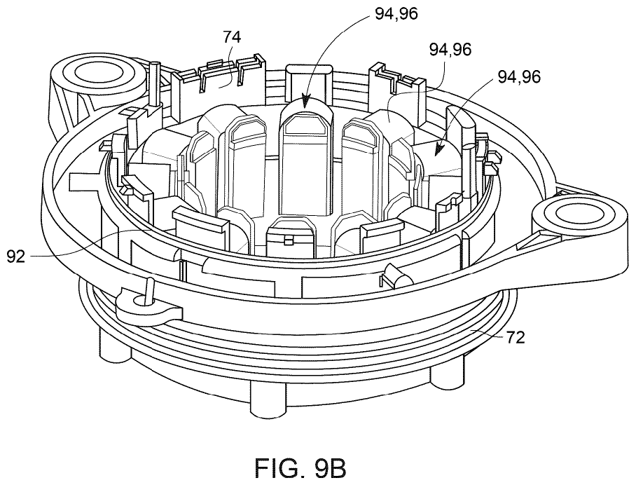

FIG. 8 shows an exploded view of parts of the pump system of FIG. 2, according to an embodiment. FIG. 9A illustrates an embodiment of some of the assembled motor parts for an electric motor 32, to be used in the exemplary illustrated pump system 100. As noted previously, the electric motor 32 includes rotor 24 (seen in the exploded view of FIG. 8, for example) and stator 26. In this case, lamination stack 80 of the stator 26 is configured for assembly via its parts being mounted between a first motor housing portion 72 and a second motor housing portion 74. Generally, the first motor housing portion 72 is incorporated as part of (i.e., internally and within) the motor housing 28 as shown in FIG. 9A, with the second motor housing portion 74 attached to the lamination stack 80 and assembled therewith. The housing portions 72 and 74 are internal parts provided within the system, as further evident below and in view of the drawings. The housing portions 72 and 74 receive additional stator parts and thus support and retain the stack 80 and magnetic wire/windings of the stator 26, according to embodiments. When the stator 26 is assembled, the second motor housing portion 74 is configured for insertion into—or in the alternative, configured to be covered by—a motor cover 35 (optional) and cover 36 (optional), as shown in FIG. 4, for example. Motor cover 35/cover 36 and first motor housing portion 72 are connected together to form a motor cavity 30 therein, in which the stator parts are provided as part of the assembly of electric motor 32. However, the optional motor cover 35 and cover 36 are removed as shown in FIGS. 9A-9B to illustrate the stator parts within the first motor housing portion 72. Also shown in FIG. 4 is optional cover 36 for the pump system 100, which is designed to cover or enclose the optional motor cover 35, as part of the system housing 104. In addition, intermediate housing wall 40 is designed to be attached to a mounting end 75 (e.g., bottom) of first motor housing portion 72, seen in FIGS. 2 and 4. Intermediate housing wall 40 acts as a cover member for covering both the pump 102 as well as the electric motor 32 by connecting to both pump housing 20 and motor housing 28 (and, more specifically, intermediate housing wall 40 connects to first motor housing portion 72). In embodiments, the intermediate housing wall 40 is sealed to the mounting end 75 of the first motor housing portion 72 via one of more seals, to cover the lower part of the motor and seal the motor housing 28. For example, as shown in FIG. 4, at least one O-ring 71 may be provided between the intermediate housing wall 40 and first motor housing portion 72. Optionally, first motor housing portion 72 may include external O-ring seals 73 provided therein for assisting in sealing the motor housing 28 and system 104 when the pump system 100 is mounted in a system. As previously mentioned, intermediate housing wall 40 may be made from either plastic or metal, depending on pressure requirements and/or user requirements.

Turning back to the assembly of the electric motor 32, the first motor housing portion 72 acts as part of a first end frame for the stator parts, wherein as the second motor housing portion 74 acts part of a second end frame. In embodiments, second motor housing portion 74 is a separate piece attached to the first motor housing 72. In embodiments, second motor housing portion 74 may be molded onto the stator 26. According to an embodiment, the second motor housing portion 74 may be directly overmolded to the stator 26, including connection terminals. Such direct overmolding enables better compensation for tolerances. However, such overmolding is not required and the second motor housing portion 74 may assembled over the first motor housing portion 72.

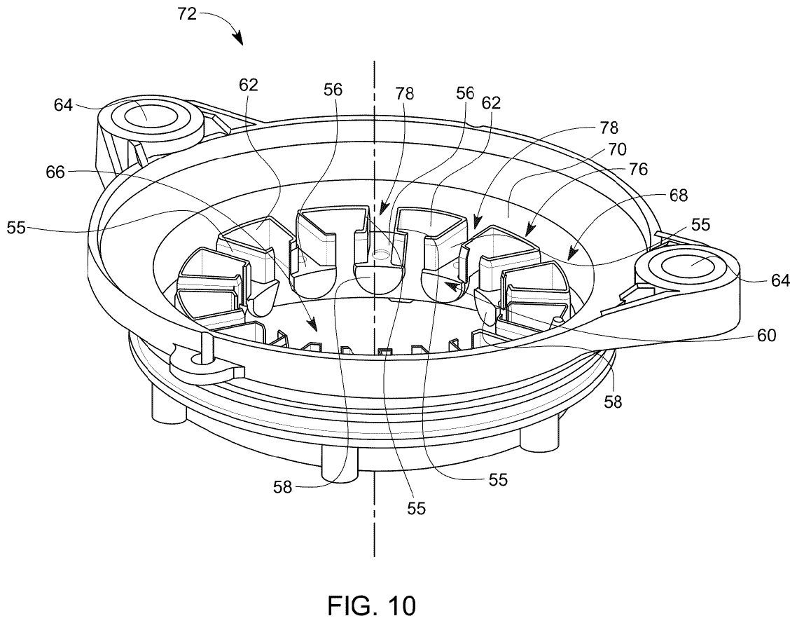

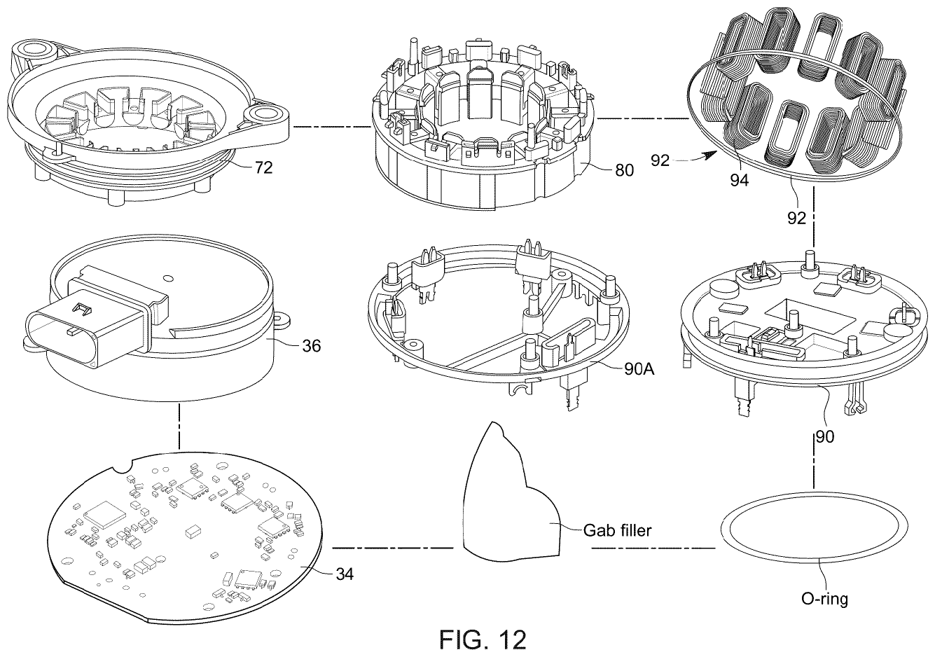

More specifically, as shown FIG. 10 and in the exploded view of the motor parts of FIGS. 11-12, the first motor housing portion 72 includes an integrated internal frame 76. Internal frame 76 is shaped to receive parts of the stator 26 therein. According to an embodiment of this disclosure, the integrated internal frame 76 is integrated as part of the first motor housing portion 72 during the manufacturing process, such that the elements are formed as a single, continuous part. In an embodiment, the first motor housing portion 72 and internal frame 76 are molded simultaneously. In one embodiment, the first motor housing portion 72 and internal frame 76 are injection-molded from plastic. However, it should be noted that the internal frame 76 and first motor housing portion 72 may be separately molded (e.g., from plastic) and then secured to each other to form an integrated design. For example, each part may be molded and then fastened using known techniques, such as via bonding or via adhesive. According to embodiments, a receiving slot 68 (see FIGS. 10-11) is provided about an internal circumference of the first motor housing portion 72, supported by a surrounding wall 70 enclosing integrated internal frame 76. The slot 68 provides spacing between the surrounding wall 70 of the motor housing and the internal frame 76. In embodiments, multiple receiving pockets 78, shown as slots extending radially in from the slot 68 and extending towards center opening 66, may be provided in the internal frame 76 for receiving radially extending portions, i.e., of teeth 82 (described below), of the stator 26 therein. Each of the multiple receiving pockets 78 includes two vertically extending side walls 55 extending from a bottom wall 56. The receiving pockets 78 are spaced about and around center opening 66, according to embodiments. In embodiments, at ends of each of the receiving pockets 78, downwardly extending (as depicted in FIG. 10) flanges 58 are provided which extend down from an inner edge 60 of the internal frame 76 and assist in defining center opening 66. The flanges 58 may be provided and designed so that when wire 96 for windings 94 is wound around the stator teeth 82 (e.g., to result in the assembly of FIG. 9b), the wire 96 may be directed and configured to be wrapped under bottom wall 56 of each receiving pocket 78 and each flange 58 helps to locate the wire 96 and maintain the wire 96 in place. The wire 96 (which is typically insulated) is wrapped multiple times therearound, to thereby form the windings 94. Spaces 62 are provided between side walls 55 of adjacent pockets 78. The spaces 62 are dimensioned and designed based on the lamination stack 80 which is inserted into the motor housing portion 72. The spaces 62 accommodate windings 94 which are inserted through the stator 26 and spaces 62. First motor housing portion 72 may further include any number of fastener openings 64 (e.g., for receiving bolts) for securing the portion 72 to the assembly of the pump system 100 (see FIG. 2). Center opening 66 is provided in first motor housing 72 to accommodate other parts (e.g., drive shaft 18, rotor 24) of the pump system 100 upon assembly. In accordance with embodiments, the receiving pockets 78 have an outer curved shape for easier assembly of the lamination stack (normal). The slot 68 or spacing outwards from the pockets (before the surrounding wall 70) allows for parts (e.g., second motor housing portion 74) to be inserted therein and then laser welding performed such that first motor housing portion 72 is secured to the cover 35 to close the module. Alternatively and/or also different connection/sealing methods between first motor housing portion 72 and cover 35 may be used, e.g., instead of laser welding (e.g. O-ring+screws/bolts) according to embodiments herein.

FIG. 11 shows an embodiment wherein the stator 26 includes a lamination stack 80 of electrical conductors formed with radially extending teeth 82 with slots 84 therebetween. Each tooth 82 extends radially inwardly from an outer circular base 86 towards a center axis (i.e., drive axis A-A) and ends in tooth shoe 88. Each tooth 82 is a narrower portion, whereas each shoe 88 is a wider portion. During assembly, the base 86 of the stack 80 is designed for insertion into the receiving slot 68 provided about the internal circumference of the first motor housing portion 72, supported by the surrounding wall 70. That is, in an embodiment, slot 68 is configured to receive at least part (e.g., a lower half) of the base 86 of the lamination stack 80, such that the wall 70 surrounds and assists in axially supporting the stator 26 (or, at least the lower half thereof). The receiving slot 68 may be circular channel running behind the receiving pockets 78. In an embodiment, the receiving pockets 78 may be spaced inward from the surrounding wall 70 and define an inner part or side of that channel/slot 68. Each tooth 82 is configured for insertion into one of the receiving pocket 78 on the internal frame 76 so that it faces radially inward toward the rotor. Each receiving pocket 78 may be shaped and sized (e.g., width, depth) based on the shape and size of each tooth 82 as formed in the lamination stack 80, according to embodiments herein. In embodiments, a depth or height of the receiving pockets 78 is designed to receive at least half of a height or depth of the teeth 82 received therein. That is, in an embodiment, at least a lower half of parts—i.e., parts that extend below a center of the stator and inwardly towards the center (axis)—of the stator 26 are configured for placement into the first motor housing portion 72. Seating the lamination stack 80 in the first motor housing portion 72 assists in preventing any rotation of the stator 26 relative to the rotor 24 (e.g., as the rotor is rotated).

According to an embodiment, the lamination stack 80 of the stator, also referred to as lamination core, is formed from a stack of laminations stamped from sheets of metal, such as (but not limited to) electrical steel. Generally, in an embodiment, each sheet may be approximately 1 mm thick. It is noted that one skilled in the art understands that the shape of the slots and teeth of such a lamination stack is dependent upon the design of the electric machine, and that such slots may be rectangular, may taper, may be circular, etc. However, the lamination stack 80 and principles disclosed herein are applicable for different motor sizes and/or slot numbers and is not limited to a specific type or design. As generally known and understood by those skilled in the art, the lamination stack 80 of the stator 26 may be overmolded with the second motor housing portion 74. The process for overmolding may include previous mentioned steps, e.g., directly overmolding second motor housing portion 74 to the stator 26, including connection terminals, and/or assembling the second motor housing portion 74 to the first motor housing portion 72 and attachment of the portions together. The first motor housing portion 72, which acts a bottom of the bobbin, is effectively enhanced with housing function (customer sealing interface). After providing the housing portions 72, 74, the entire package may be wound together with the wires, thereby eliminating and/or reducing any additional need of other fixation methods.

FIG. 11 shows an example of the parts that are part of second motor housing portion 74 that may be overmolded onto stack 80. For example, the motor housing portion 74 may include a frame that surrounds the stack 80. The motor housing portion 74 may further optionally include a number of terminal portions for wires and the like extending from a sealing plate 90. The sealing plate 90 may include a number of terminals (e.g., ground terminals, temperature terminals, and the like) that are provided in a frame and overmolded with a conductive layer for communicating with printed circuit board (PCB) 34. The sealing plate may have an opening through a center thereof in embodiments to accommodate drive shaft 18 extending therethrough. Such features are generally understood by those skilled in the art and thus not further described her. In another embodiment, shown in FIG. 11, for example, a terminal plate 90A may be utilized as an alternative to sealing plate 90. Like sealing plate, terminal plate 90A may include terminal areas therearound for placement of terminals within and adjacent to the PCB 34. When the second motor housing portion 74 is overmolded onto the stack 80, it includes a plurality of seats 95. Each of the seats 95 may be provided with an end flange 98 to accommodate and hold windings thereon, in accordance with embodiments. The seats 95 are designed for placement over at least top portions of the stack 80 and receive a plurality of wound wires 96 therearound, as described below.

During assembly, this portion of the stator, with the stack 80 and overmolded motor housing portion 74 thereon, is configured to be fit and placed together into the first motor housing portion 72, which is shown in FIG. 9A. Turning back to FIG. 11, alternating slots 84 are provided between the teeth 82 of the stator's lamination stack 80, the teeth 82 of which are received in the receiving pockets 78 of the internal frame 76 of the first motor housing portion 72, to result in the assembly shown in FIG. 9A. After placement of the stack 80 therein, then, wires 96 of insulated conductors are designed to be wound around and pass through slots 84 of the lamination stack 80 and the spaces 62 of the first motor housing portion 72, under the bottom walls 56 (held on by flanges 55) and around the side walls 55 of the receiving pockets 78, and around seats 95, to form windings 94. As shown in FIGS. 11-12, for example, a motor support O-ring 92 and a number of winding heads 94 (also called bobbins of wire) formed of insulated conductor wires are placed on and in the assembly to form the electric motor 32. Each winding head 94 has a plurality of wires 96 wound therearound. As understood by those skilled in the art, in accordance with embodiments, the insulated conductor wires 96 may be wound around the seats 95 and teeth 82 et al. by a machine designed to weave the wires within, around, and through the slots 84 and seats 95 so as to form the electric motor 32, forming the assembly shown in FIG. 9B. Wires 96 may run from one “coil” of windings 94 to the next or adjacent ones, according to embodiments herein. In a non-limiting embodiment, a three-phase motor may be utilized, i.e., twelve windings 94 or coils, wherein four windings 94 are formed by one set of wires. The wires may be connected to hooks for connection to the PCB 34, as is generally understood by those skilled in the art. O-ring 92 may be used for support purposes, for example, as generally known in the art of motors. The insulated wires 96/windings 94 are held by end flange 98 on seats 95 and around the stack 80. The winding heads 94 are thus provided in the lower, first motor housing portion 72, as shown in FIGS. 3 and 4. The windings 94, second motor housing portion 74, and first motor housing portion 72 via internal frame 76 are thus directly fixed, as the placement of the wires 96 of windings therearound the previously mentioned parts (i.e., sets 85, teeth 82, walls 55 and 56, etc.) holds them all together, with no additional fixation features being required. An example of such is seen in FIGS. 9A-9B, for example. Placement and winding of wires 96 to form windings 94 in the first motor housing portion 72 further assists in preventing any relative rotation of the stator 26, because the winding heads 94 are held in place, which in turn prevents any rotational slippage of the stator due to thermal expansion difference between the plastic and the metal of the stator 26. In fact, second motor housing portion 74 is also substantially prevented from relative movement and also fixed thereto by placement on the overmolded stator portion before the windings are added, thus forming the stator 26 of the motor.

Accordingly, in an embodiment, this disclosure provides a lower motor housing portion 72 that is formed from plastic and designed for receipt of a metal stator 26. The motor housing portion 72 includes an outer surrounding wall 70 that surrounds parts of the stator 26 and supports the stator 26 axially via seats and an internal frame 76 that extends from the wall 70. The internal frame 76 and motor housing portion 72 assist in retaining the stator parts (lamination stack 80, windings 94) against rotation relative to the rotor 26 during use. Further, these seats/frame receive a portion of the stator windings, which extend inwardly below the lamination stack 80. In addition, adding the winding heads 94 after fitting the overmolded stator and motor housing portion 74 into the first motor housing portion 72 further secures the parts of the stator 26.

FIG. 11 further shows the steps of assembly of the additional parts on the motor side of the pump system 100, according to a non-limiting embodiment. After winding is complete, the sealing plate 90 (or terminal plate 90A) may be press-fit on top of the assembly of FIG. 9A, i.e., to the wire windings. Heat staking may then be performed, along with the addition of O-ring to an outer side of the sealing plate 90, according to an embodiment. Glue (or adhesive) and gap filler may then be dispensed on the assembly. Thereafter, the PCB 34 may be fit on top of the assembly, with heat staking for securement. The motor cover 35 and/or cover 36 may then be secured or welded (e.g., laser welded, plastic welding) to the first motor housing portion 72, the cover the parts of the motor therein.

In embodiments, the first motor housing portion 72 is designed to include seals and a mounting portion to which the pump 102 is secured via intermediate housing wall 40, as well as optional external seal(s) for mounting the pump system.

In an embodiment, the rotor 24 may be formed from a stack of laminations that correspond to those of the stator 26. In some cases, for example, corresponding laminations for the rotor 24 and the stator 26 may be stamped simultaneously from the same metal sheet. Generally, the rotor includes a number of slots and teeth that are larger than the number of slots and teeth of the stator. The rotor and stator have a gap therebetween such that the rotor is configured to rotate relative to the stator. In an embodiment, the gap between the rotor and stator is kept as small as possible, e.g., 1-2 mm.

The disclosed design for the motor housing 28 removes the traditional separate housing components and combines the interfacing/assembly features of the traditional housing with the lower portion of the motor stator assembly. Further, such parts may be made from plastic. External interfaces include O-ring sealing interfaces and screw holes for mounting to external environment. Internal interfaces include O-ring sealing interface to pump cover and threaded holes for mounting the pump assembly to the motor. Enhanced lower, first motor housing portion 72 is directly fixed to the rest of the stator assembly via the windings, thus no additional fixation of the stator required. A cover is bonded to the upper portion of the first motor housing portion 72 to encapsulate the motor and controller.

As such, the disclosed design provides a reduced bill of materials, reduced size, and reduces weight of the assembly/pump system. This design also removes interference fit and/or screwing process to fix stator to housing. By removing the standard metal (e.g., aluminum) housing, costs are reduced. The motor housing also provides an interface to external environment when the pump system 100 is mounted, and seals may be added as needed. In addition, the disclosed design helps reduce and/or eliminate thermal expansion issues, location tolerances, and alignment issues (e.g., reducing and/or removing engineering and quality challenges that come with fixing a stator to a housing and aligning it with the pump assembly). Further, providing windings around the housing - not turning inside housings - also stops slippage in housing.

As such, this disclosure relates to, among other features, a pump system that includes a housing with a pump for pumping a liquid and an electric motor therein. A stator of the electric motor has a lamination stack, the lamination stack being mounted between a first motor housing portion and a second motor housing portion. The second motor housing portion is attached to the lamination stack, and the first motor housing portion includes an integrated internal frame shaped to receive the lamination stack and parts of the stator therein, the first motor housing portion forming part of a motor housing for the electric motor. The integrated internal frame and the first motor housing portion may be formed as a single, continuous part, e.g., molded from plastic.

In addition to providing the disclosed pump system, this disclosure also encompasses a method of manufacturing such a pump system 100. Such method includes, but is not limited to: providing and integrating the integrated internal frame as part of the first motor housing portion such that the elements are formed as a single, continuous part; providing the lamination stack in the first motor housing portion; and overmolding the second motor housing portion onto the stator.

Further, this disclosure includes a vehicle having a device to receive liquid as well as the disclosed pump system 100 coupled to the device to deliver the liquid thereto, wherein the pump system 100 is installed with the overflow opening positioned substantially vertically above the drive shaft and the pump inlet return port. Such a device that receives liquid may be, for example, a clutch or a transmission, in accordance with embodiments.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A pump system comprising:
a housing with a pump for pumping a liquid and an electric motor therein;
a stator of the electric motor, the stator comprising a lamination stack, the lamination stack being mounted between a first motor housing portion and a second motor housing portion,
the second motor housing portion being attached to the lamination stack, and
the first motor housing portion including an integrated internal frame shaped to receive the lamination stack and parts of the stator therein, the first motor housing portion forming part of a motor housing for the electric motor.

2. The pump system according to claim 1, wherein the integrated internal frame and the first motor housing portion are formed as a single, continuous part.

3. The pump system according to claim 2, wherein the first motor housing portion and internal frame are molded from plastic.

4. The pump system according to claim 1, further comprising a cover secured to the first motor housing portion to enclose the stator and electric motor parts therein.

5. The pump system according to claim 1, wherein the first motor housing portion comprises a receiving slot provided about an internal circumference thereof.

6. The pump system according to claim 5, wherein the first motor housing portion comprises a surrounding wall enclosing the integrated internal frame, and wherein the receiving slot provides space between the surrounding wall and the internal frame.

7. The pump system according to claim 5, wherein the lamination stack of the stator comprises radially extending teeth with slots therebetween, each tooth extending radially inwardly towards a center axis from a base, and wherein the base of the lamination stack is designed for insertion into the receiving slot of the first motor housing portion.

8. The pump system according to claim 7, wherein the integrated internal frame comprises multiple receiving pockets or slots spaced about and around a center opening in the integrated internal frame, said multiple receiving pockets or slots configured to receive at least a portion of each tooth of the stator therein.

9. The pump system according to claim 8, wherein the integrated internal frame further comprises flanges provided at or near each of the receiving pockets for locating and maintaining windings of the stator thereon.

10. The pump system according to claim 1, wherein at least part of second motor housing portion is overmolded onto the lamination stack.

11. The pump system according to claim 10, further comprise a plate having a number of terminals.

12. The pump system according to claim 1, further comprising
a pump inlet comprising a pump inlet port;
a pump outlet comprising a pump outlet port;
a drive shaft rotatably driven by the electric motor, for driving the pump to pressurize fluid received through a fluid path of the pump from the pump inlet for output to the pump outlet.

13. A method of manufacturing the pump system according to claim 1, the method comprising:
providing and integrating the integrated internal frame as part of the first motor housing portion such that the elements are formed as a single, continuous part;
providing the lamination stack in the first motor housing portion; and
overmolding the second motor housing portion onto the stator.

14. A vehicle comprising the pump system of claim 1.
